(19) United States
(12) Patent Application Publication
(10) Pub. No.: US 2025/0179327 A1
(43) Pub. Date: Jun. 5, 2025

(54) FLUORINE-FREE COATING COMPOSITION

(71) Applicant: UNILIN, BV, Wielsbeke (BE)

(72) Inventors: Raul PRIETO, Senden (DE); Martin SEGAERT, Wielsbeke (BE)

(21) Appl. No.: 18/842,916

(22) PCT Filed: Mar. 7, 2023
(86) PCT No.: PCT/IB2023/052148

§ 371 Date: Aug. 30, 2024

(30) Foreign Application Priority Data
Mar. 8, 2022 (EP) 22160943.1
Mar. 15, 2022 (BE) 2022/5176
Apr. 5, 2022 (BE) 2022/5261
Jun. 10, 2022 (BE) 2022/5449
Jan. 4, 2023 (BE) 2023/5002

(51) Int. Cl. C09D 167/00; C08K 5/29; C08K 5/54; C09D 191/08

(52) U.S. Cl. CPC C09D 167/00; C08K 5/29; C08K 5/5403; C09D 191/08

(57) ABSTRACT

The use is described of a fluorine-free coating composition which comprises at least one polycarbodiimide compound, the at least one polycarbodiimide compound having at least two hydrocarbon groups each having at least 4 carbon atoms, for impregnating floor coverings. Carpets are not included. Also presented are a fluorine-free coating composition and a floor covering coated with this composition.

The invention relates to the use of a fluorine-free coating composition, to a fluorine-free coating composition and to a floor covering coated with the coating composition.

Floor coverings such as laminate or parquet are nowadays joined to one another usually mechanically and no longer by means of adhesives. In this context, constructions of tongue and groove have become established.

The coverings, however, have the problem that water or cleaning chemicals penetrate the joints. As a result, the coverings swell in the edge regions. Irregular, relatively unattractive surfaces, and trip hazards resulting from them, are the consequence. Furthermore, the water may run through the joints beneath the floor covering; as a result, water may get into the floor or cause mould.

In the prior art, therefore, oils or waxes are used, as impregnating agents for floor coverings, and repel water or aqueous solutions in particular. However, these remedies do not completely dry, offer only superficial protection or do not last. Furthermore, waxes are very difficult to apply. High layer thicknesses are the consequence, and so the individual boards cannot be properly joined to one another. Furthermore, the substances used frequently contain fluorine, which is detrimental both to the environment and to the users.

There was therefore a desire for a coating material for floor coverings, particularly for the interior, which can be applied in the edge region of floor covering elements or over the full area and offers sufficient protection against water and cleaning chemicals. For environmental reasons, moreover, the coating materials ought to be fluorine-free. They ought to be easy to apply and penetrate sufficiently into the floor material.

It has been possible to achieve this object through the use of a fluorine-free coating composition for impregnating floor coverings. This composition comprises at least one polycarbodiimide compound a, where the at least one polycarbodiimide compound preferably has at least two hydrocarbon groups each having at least 4 carbon atoms, preferably at least 12 carbon atoms, more preferably at least 16 carbon atoms.

The composition used in the invention is employed in order to raise the water-repelling effect of substrates.

A “fluorine-free” coating composition means here that a composition which is used for impregnating contains less than 1 weight percent (1 wt %) of fluorine in a composition. In certain embodiments, a “fluorine-free” coating composition means that a coating composition contains preferably less than 0.5 wt %, less than 0.1 wt % or less than 0.01 wt %. The fluorine may be present in the form of organic or inorganic fluorine-containing compounds.

The polycarbodiimide compounds have at least two hydrocarbon groups each containing at least 4 carbon atoms. In certain embodiments, useful polycarbodiimide compounds are from a carbodiimidization reaction (i.e. a reaction in which (N═C═N) groups are formed) of a carbodiimidization reaction mixture which comprises at least one oligomer, where such an oligomer contains at least one (typically one) isocyanate end group and at least two repeating units, with each of the at least two repeating units having at least one (typically one) hydrocarbon group having at least 4 carbon atoms (and in certain embodiments up to 60 carbon atoms or up to 30 carbon atoms).

In one embodiment of the invention the at least one polycarbodiimide compound comes from a carbodiimidization reaction of a carbodiimidization reaction mixture which comprises at least one oligomer, where the oligomer comprises at least one isocyanate end group and at least two repeating units, each of the at least two repeating units comprising at least one hydrocarbon group having at least 4 carbon atoms. In a further embodiment, the polycarbodiimide compound comes from a carbodiimidization reaction of a carbodiimidization reaction mixture which comprises 4,4′-methylenebis(phenyl isocyanate) and an acrylate oligomer in a molar ratio of 2:1 to 10:1, where the acrylate oligomer is prepared by reaction of an oligomerisation reaction mixture which comprises mercaptoethanol and octadecyl acrylate in a molar ratio of 1:4 to 1:20, or of an oligomerisation reaction mixture which comprises mercaptoethanol and a reaction product of octadecyl isocyanate with 2-hydroxyethyl (meth)acrylate or octadecyl isocyanate with 2-isocyanatoethyl (meth)acrylate, the mercaptoethanol and the reaction product being reacted in a molar ratio of 1:4 to 1:20.

Oligomers comprise compounds having at least 2 and up to 20 repeating units. According to one particular embodiment, the oligomer has 3 to 15 repeating units. According to another embodiment, the oligomer has 4 to 15 repeating units. In certain embodiments, an oligomer has a weight-average molecular weight of up to 50 000 g/mol.

It is preferred for the composition to comprise at least one paraffin wax b. The paraffin wax preferably has a melting point of 40° C. to 75° C. In preferred embodiments, the paraffin wax has a melting point of 60° C. to 75° C. The mass ratio of paraffin wax b to polycarbodiimide a is preferably 3:7 to 7:3, more preferably 5:5 to 7:3.

The fraction of polycarbodiimide compound and paraffin wax in the composition is preferably 1 to 20 wt %, based on the total weight of the composition.

Suitable polycarbodiimide compounds and paraffin waxes and also their preparation are described for example in U.S. Pat. No. 11,124,918 B2.

The coating composition preferably comprises at least one polymer c selected from alkyd resins, acrylate resins, polyurethane-modified polyesters, silanes, siloxanes or mixtures thereof. The fraction of the polymer is preferably 5 to 40 wt %, based on the total weight of the composition. The polymers may carry ionic groups, such as sulfonic acid groups, for example.

The alkyd resin may for example be a long-oil or medium-oil alkyd. In the case of long-oil alkyds, the alkyd resins in question have a fatty acid content of more than 60%; medium-oil alkyds comprise 40 to 60% of fatty acids. Suitable fatty acids are, for example, vegetable fatty acids. The acid number is preferably less than 20 mg KOH/g; the iodine number is preferably less than 20. The alkyd resin may be urethane- or isocyanate-modified or not, in order to promote water resistance. The advantage is threefold: as well as the price advantage, the alkyd not only provides an increased viscosity, but also, particularly in the case of a medium- or long-chain resin, it penetrates less deeply into the wood and can form a first barrier, owing to its low scatter. The resin forms an outer film. Since a relatively thin layer is applied, the coating does not have to be dried, so as to meet the current environmental standards (AgbB [German Committee for Health-Related Evaluation of Building Products], etc).

Acrylate resins may be straight acrylates or styrene acrylates. Suitable monomers are, for example, methyl methacrylate, styrene, acrylonitrile, butyl methacrylate, ethyl acrylate, butyl acrylate or ethylhexyl acrylate. It is possible, moreover, for monomers such as, for instance, methacrylic acid, glycidyl methacrylate, 3-(trimethoxysilyl) propyl methacrylate, acetoacetoxyethyl methacrylate, acrylic acid, itaconic acid or diacetoneacrylamide to be incorporated. Suitable acrylate resins are available for example from BASF (Germany) under the name Joncryl.

Polyurethane-modified polyesters are, for example, branched, unsaturated, aromatic or aliphatic polymers. They have a number-average molecular weight of between 1000 and 20 000 g/mol. The fraction of free OH groups is preferably 0.5 to 5 wt %, based on the total weight of the polyester.

Silanes may have 1 to 10 carbons, preferably 2 to 6 carbons. They may contain aminoalkyl and/or alkoxy groups having 1 to 10 carbons, preferably 1 to 6 carbons.

Siloxanes comprise, for example, cyclosiloxanes and/or polysiloxanes, with the siloxane monomer unit having one to 12 carbons. In the side groups they may carry alkyl, alkenyl such as vinyl, aryl such as phenyl, amino, alkoxy or H groups. The alkyl groups are preferred, with methyl (polydimethylsiloxanes PDMS), methoxy or ethoxy groups being particularly preferred. Suitable siloxanes are available for example from Dow Corning (USA.)—Dowsil products, Evonik (Germany)—Tegophobe 6600, Wacker (Germany)—TES28, Momentive (USA.)—Silquest products.

The polymers stated above may be used in particular in the form of solutions or dispersions.

In one preferred embodiment, the mass ratio of (polycarbodiimide compound a +paraffin wax b):polymer c is 10:90 to 90:10, preferably 70:30 to 95:5.

The coating composition comprises preferably at least one solvent d. These include not only water but also organic solvents, with water or aqueous mixtures being preferred. Water and aqueous mixtures are advantageous because they are particularly eco-friendly. Solvent mixtures are preferably homogeneous. Suitable organic solvents are alkanes, including branched alkanes, preferably having 10 to 20 carbon atoms, alcohols having 1 to 6, preferably 1 to 4, carbons, and esters such as acetates from alcohols having 1 to 10 carbons. Ethyl acetate is less preferable, as it poses an explosion hazard. For aqueous mixtures, hydrophilic organic solvents which are miscible with water are especially suitable such as alcohols, for example. The fraction of solvent is preferably 20 to 95 wt %, based on the total weight of the composition.

For water-free coating materials, polymers selected are, in particular, alkyd resins, silanes or siloxanes. Aqueous coating materials preferably comprise acrylate resins, polyurethane-modified polyesters, silanes or siloxanes as polymers.

The coating composition may comprise additives such as surfactants, surface-active agents, coalescing solvents, anti-freeze agents, emulsifiers or stabilizers to counter one or more microorganisms. Suitable additives are disclosed in U.S. Pat. No. 11,124,918 B2. It is preferred for the coating composition to be homogeneous. The fraction of additives is preferably 0.1 to 20 wt %, based on the total weight of composition.

The coating composition may comprise 1 to 10 wt %, based on the total weight of the composition, of colorants such as dyes or pigments. These colorants are able, for example, to cover the lines which form during milling or the appearance of different materials. These colorants are not intended in particular to have any effect on the water resistance and water repulsion.

To produce the coating composition, the individual constituents can be added and mixed with one another via stirrers, for example. The individual constituents may have been dissolved beforehand in suitable solvents.

Suitable substrates are floor coverings, with covering for the interior being preferred. These comprise homogeneous or heterogeneous plastic coverings, for example comprising polyvinyl chloride, polyolefins, rubber, linoleum or quartz vinyl. Cork is also suitable. The aforesaid coverings are elastic coverings. Additionally included may be laminate floors, parquet, including engineered wood floors, and plank floors. The latter are among the hard coverings. They are commonly fabricated from wood such as solid wood, veneer or chipboard. Furthermore, mineral substrates may be included, with elastic and hard coverings being preferred. Substrates not encompassed are carpets.

The coverings may be homogeneous, i.e. composed of a single material, or may be fabricated from a mixture. Included among these, for example, are floor coverings such as solid polymer core (SPC) or wood-plastic compound (WPC). Moreover, the coverings may be multi-layer, such as cushioned vinyl, for example, or laminates, which comprise, for example, high-density fibreboard (HDF) or medium-density fibreboard (MDF). The coverings may have, for example, a foam coating. The coverings may comprise a decorative top layer and may for example be patterned or of single colour.

The coating composition may be applied to the edges of the floor coverings, the top or bottom side, or to the entire area. The application of the coating composition to the edges of floor coverings (frequently in the form of floor panels) is first accomplished by means of a transfer technique, in which the composition is first applied to a wheel or a roll and then transferred by the wheel or the roll to the edge of the panel.

This application process resembles that described in WO 2006/038867. The solvent-based or water-based mixture may possibly have a low viscosity, and so it is not easily picked up by the wheel and easily flows back from the wheel into the liquid reservoir.

In addition to transfer application, the composition of the invention may be applied in a spraying process, more particularly an automated process, by means of high-pressure spraying processes, for example, or else applied by manual application such as brush or roller. The advantage of such a utility is that a higher layer thickness can be achieved, which improves the water resistance.

The coating composition is applied preferably in an amount corresponding to 0.1 to 30 g/m², preferably 1 to 10 g/m² (dry layer).

A further subject of the invention are fluorine-free coating compositions which include at least one polymer c selected from alkyd resins, acrylate resins, polyurethane-modified polyesters, silanes, siloxanes or mixtures thereof and also preferably at least one polycarbodiimide compound a, the at least one polycarbodiimide compound having at least two hydrocarbon groups each having at least 4 carbon atoms. The composition preferably comprises at least one paraffin wax b. Moreover, the composition preferably comprises at least one solvent d. The definitions of polymer, polycarbodiimide, paraffin wax and solvent have already been described above.

A further aspect of the invention is a floor covering coated partly or entirely with the coating composition of the invention. Preferred floor coverings have already been stated above.

### EXAMPLES

Uncoated MDF/HDF laminate boards were coated with coating compositions. To determine the quality of impregnation here, the contact angle and also the swelling of the edge were ascertained.

### Tests

### Contact Angle Measurement

Edges of unprocessed, uncoated MDF/HDF laminate boards are coated by brush; drying: at least 24 h at RT; via a contact angle instrument (OK 15E10), water droplets (0.2 mL to 0.3 mL) are placed onto the edge; contact angle measurement
<90°: hydrophilic
>90° to 130°: hydrophobic
>130°: superhydrophobic

### Edge Swelling

Drying times: at least 24 h at RT

Unprocessed, uncoated MDF/HDF laminate boards, in each case with tongue or groove, 7×15 cm, have their edge thicknesses measured with a thickness gauge at various points; the boards are then coated by brush; application rates are ascertained via re-weighing, and the application rate is calculated and ascertained as g/m² (around 2 to 5 g/m²); laminate is clicked together under tension via tongue/groove, and the joints clicked together are wetted with a wet cloth at pre-defined weight; viewing tests and thickness measurement after 12 h by means of inspection
1. very severe swelling
2. severe swelling
3. slight swelling
4. barely visible swelling
5. no swelling
   by means of thickness gauge (Käfer FD50); the thickness ought to be not more than 0.1 mm

### EXAMPLES

TABLE 1
Aqueous coating compositions

| | Comparative | | |
|---|---|---|---|
| | Example 1 | Example 1 | Example 2 |
| Polycarbodiimide compound + | 0.25 | 6 | 6 |
| paraffin wax | | | |
| Silane | 2 | 5 | 10 |
| Polyurethane-modified | 4 | 10 | 20 |
| polyesters | | | |
| Organic solvents | — | — | — |
| Water | 91.75 | 69 | 54 |
| Additives | 2 | 10 | 10 |

TABLE 2
Determination of the impregnating effect
of aqueous coating compositions

| | Comparative | | |
|---|---|---|---|
| | Example 1 | Example 1 | Example 2 |
| Contact angle | 85° | 120° | 125° |
| Measurement thickness/mm | 0.5 | 0.1 | 0.1 |
| Visual evaluation | 2 | 5 | 5 |

TABLE 3
Non-aqueous coating compositions

| | Comparative | | |
|---|---|---|---|
| | Example 2 | Example 3 | Example 4 |
| Polycarbodiimide compound + | 0.25 | 5 | 7.5 |
| paraffin wax | | | |
| Silane | 1 | 5 | 2.5 |
| Alkyd resin | 1.8 | 9 | 9 |
| Organic solvents | 94.95 | 76 | 71 |
| Water | — | — | — |
| Additives | 2 | 5 | 10 |

TABLE 4
Determination of the impregnating effect
of non-aqueous coating compositions

| | Comparative | | |
|---|---|---|---|
| | Example 2 | Example 3 | Example 4 |
| Contact angle | 70° | 110° | 127° |
| Measurement thickness/mm | 0.6 | 0.1 | 0.1 |
| Visual evaluation | 1 | 4-5 | 5 |

Examples 1 to 4 demonstrate that the coating compositions of the invention at laminate edges exhibit a high hydrophobic, impregnating effect and there are no instance of swelling due to water contact.

1.-11. (canceled)

12. A use of a fluorine-free coating composition comprising:
a. at least one polycarbodiimide compound,
for impregnating floor coverings, not including carpets.

13. The use according to claim 12, wherein the coating composition comprises:
b. at least one paraffin wax.

14. The use according to claim 13, wherein the mass ratio of paraffin wax to polycarbodiimide is 3:7 to 7:3.

15. The use according to claim 12, wherein the coating composition further comprises:
c. at least one polymer selected from alkyd resins, acrylate resins, polyurethane-modified polyesters, silanes, siloxanes or mixtures thereof.

16. The use according to claim 15, wherein the coating composition comprises:
b. at least one paraffin wax, and
wherein the mass ratio of (a+b):c is 10:90 to 90:10.

17. The use according to claim 12, wherein the coating composition further comprises:
d. at least one solvent.

18. The use according to claim 17, wherein said at least one solvent comprises water.

19. The use according to claim 12, wherein the at least one polycarbodiimide compound has at least two hydrocarbon groups which each have at least 4 carbon atoms.

20. The use according to claim 19, wherein the coating composition further comprises:
c. at least one polymer selected from alkyd resins, acrylate resins, polyurethane-modified polyesters, silanes, siloxanes or mixtures thereof.

21. A fluorine-free coating composition comprising:
a. at least one polymer selected from alkyd resins, acrylate resins, polyurethane-modified polyesters, silanes, siloxanes or mixtures thereof.

22. The fluorine-free coating composition according to claim 21, wherein the composition comprises:
b. at least one polycarbodiimide compound, the at least one polycarbodiimide compound having at least two hydrocarbon groups each having at least 4 carbon atoms.

23. The fluorine-free coating composition according to claim 21, wherein the composition comprises at least one paraffin wax.

24. The fluorine-free coating composition according to claim 21, wherein at least one solvent is present.

25. The fluorine-free coating composition according to claim 22, wherein at least one solvent is present.

26. A floor covering coated with a fluorine-free coating composition according to claim 21.
